(19) United States
(12) Patent Application Publication
(10) Pub. No.: US 2024/0173673 A1
(43) Pub. Date: May 30, 2024

(54) WASTEWATER TREATMENT SYSTEM

(71) Applicant: MITSUBISHI HEAVY INDUSTRIES, LTD., Tokyo (JP)

(72) Inventors: Yoshiaki Ito, Tokyo (JP); Toshihiro Fukuda, Tokyo (JP); Kaoru Egawa, Tokyo (JP)

(73) Assignee: MITSUBISHI HEAVY INDUSTRIES, LTD., Tokyo (JP)

(21) Appl. No.: 18/551,859

(22) PCT Filed: Mar. 28, 2022
(86) PCT No.: PCT/JP2022/014967

§ 371 Date: Sep. 21, 2023

(30) Foreign Application Priority Data
Apr. 2, 2021 (JP) 2021-063530

(51) Int. Cl. B01D 61/44; B01D 61/46; C02F 1/461; C02F 1/469; C02F 101/16

(52) U.S. Cl. CPC B01D 61/445; B01D 61/463; B01D 61/464; B01D 61/466; C02F 1/4618; C02F 1/4693; C02F 2001/46185; C02F 2101/16; C02F 2303/16

(57) ABSTRACT

A wastewater treatment system for treating regeneration wastewater generated by a regeneration process using an acidic aqueous solution for a desalination device for desalting water containing ammonia includes a bipolar membrane electrodialyzer for separating, from the regeneration wastewater containing an ammonia salt produced by reaction between ammonia captured by the desalination device and the acidic aqueous solution or from a solution derived from the regeneration wastewater, an aqueous solution containing an acidic solute that is the same as the acidic aqueous solution as a regeneration acidic aqueous solution. The wastewater treatment system is configured such that the regeneration acidic aqueous solution is used as at least part of the acidic aqueous solution for regeneration of the desalination device.

The present application claims priority based on Japanese Patent Application No. 2021-063530 filed on Apr. 2, 2021, the entire content of which is incorporated herein by reference.

### TECHNICAL FIELD

The present disclosure relates to a wastewater treatment system.

### BACKGROUND ART

Patent Document 1 describes a device for recovering ammonia from condensate in a plant such as a thermal power plant, and reusing wastewater after recovering ammonia in the plant. In this device, ammonia is removed from the condensate by passing the condensate through a desalination device equipped with an anion exchanger and a cation exchanger. The desalination device needs to be regenerated periodically, but the regeneration process generates regeneration wastewater. For example, if sodium hydroxide aqueous solution is used to regenerate the anion exchanger and sulfuric acid aqueous solution is used to regenerate the cation exchanger, anion exchanger regeneration wastewater containing various anions and sodium hydroxide and cation exchanger regeneration wastewater containing ammonia are generated as regeneration wastewater. In this device, ammonia gas is recovered by distilling ammonia-concentrated water concentrated from the cation exchanger regeneration wastewater. During the distillation, alkaline water obtained by separation of alkaline components from the anion exchanger regeneration wastewater through electrodialysis may be supplied to promote ammonia transfer from the ammonia-concentrated water to the gas phase.

### CITATION LIST

### Patent Literature

Patent Document 1: JP2019-98205A

### SUMMARY

### Problems to be Solved

However, chemicals such as sulfuric acid aqueous solution and sodium hydroxide aqueous solution used in a regeneration process of a desalination device are costly, and the cost of the regeneration process of the desalination device is becoming an increasing problem.

In view of the above, an object of at least one embodiment of the present disclosure is to provide a wastewater treatment system that can reduce the cost of the regeneration process of the desalination device.

### Solution to the Problems

To achieve the above object, a wastewater treatment system according to the present disclosure is a wastewater treatment system for treating regeneration wastewater generated by a regeneration process using an acidic aqueous solution for a desalination device for desalting water containing ammonia and includes a bipolar membrane electrodialyzer for separating, from the regeneration wastewater containing an ammonia salt produced by reaction between ammonia captured by the desalination device and the acidic aqueous solution or from a solution derived from the regeneration wastewater, an aqueous solution containing an acidic solute that is the same as the acidic aqueous solution as a regeneration acidic aqueous solution. The wastewater treatment system is configured such that the regeneration acidic aqueous solution is used as at least part of the acidic aqueous solution for regeneration of the desalination device.

### Advantageous Effects

With the wastewater treatment system according to the present disclosure, by separating a regeneration acidic aqueous solution from regeneration wastewater generated by regenerating the desalination device with an acidic aqueous solution or from a solution derived from the regeneration wastewater, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

### BRIEF DESCRIPTION OF DRAWINGS

FIG. 1 is a configuration diagram of a wastewater treatment system according to the first embodiment of the present disclosure.

FIG. 2 is a schematic configuration diagram of a bipolar membrane electrodialyzer provided in the wastewater treatment system according to the first embodiment of the present disclosure.

FIG. 3 is a schematic configuration diagram of a modification of the bipolar membrane electrodialyzer provided in the wastewater treatment system according to the first embodiment of the present disclosure.

FIG. 4 is a configuration diagram of a wastewater treatment system according to the second embodiment of the present disclosure.

FIG. 5 is a schematic configuration diagram of a bipolar membrane electrodialyzer provided in the wastewater treatment system according to the second embodiment of the present disclosure.

FIG. 6 is a schematic configuration diagram of a modification of the bipolar membrane electrodialyzer provided in the wastewater treatment system according to the second embodiment of the present disclosure.

FIG. 7 is a configuration diagram of a modification of the wastewater treatment system according to the first embodiment of the present disclosure.

FIG. 8 is a schematic configuration diagram of a bipolar membrane electrodialyzer provided in a modification of the wastewater treatment system according to the first embodiment of the present disclosure.

FIG. 9 is a schematic configuration diagram of a modification of the bipolar membrane electrodialyzer provided in a modification of the wastewater treatment system according to the first embodiment of the present disclosure.

FIG. 10 is a schematic configuration diagram of a bipolar membrane electrodialyzer provided in another modification of the wastewater treatment system according to the first embodiment of the present disclosure.

FIG. 11 is a schematic configuration diagram of a modification of the bipolar membrane electrodialyzer provided in another modification of the wastewater treatment system according to the first embodiment of the present disclosure.

FIG. 12 is a configuration diagram of a modification of the wastewater treatment system according to the first embodiment when the bipolar membrane electrodialyzer of FIG. 10 or FIG. 11 is used.

### DETAILED DESCRIPTION

Hereinafter, a wastewater treatment system according to embodiments of the present disclosure will be described with reference to the drawings. The following embodiments are illustrative and not intended to limit the present disclosure, and various modifications are possible within the scope of technical ideas of the present disclosure.

### First Embodiment

### <Configuration of Wastewater Treatment System According to First Embodiment of Present Disclosure>

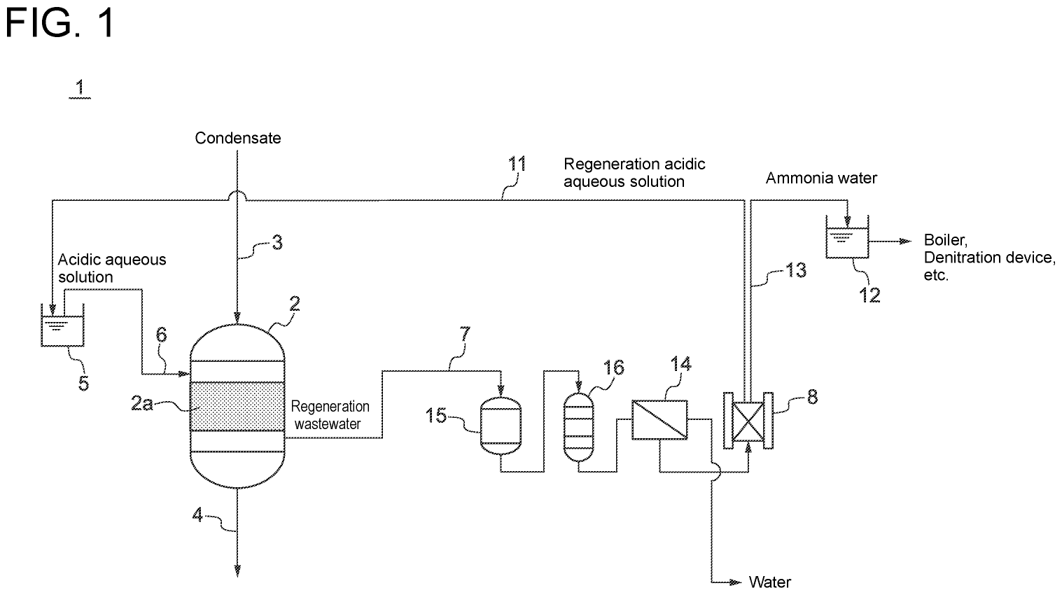

As shown in FIG. 1, a wastewater treatment system 1 according to the first embodiment of the present disclosure is to remove ammonia from water containing ammonia, for example, condensate from a boiler in a thermal power plant, i.e., to treat regeneration wastewater generated by a regeneration process of a desalination device 2 for desalting the condensate. In the first embodiment, a configuration in which the desalination device 2 includes a cation exchange resin 2a will be described. However, the present disclosure is not limited to this embodiment, and any desalination device can be used, such as those using an adsorbent or other media capable of adsorbing ammonia, as long as it has a configuration that can temporarily capture ammonia and allows ammonia to be removed from the ammonia-capturing media through a regeneration process.

The desalination device 2 is connected to a condensate inflow line 3 for supplying water containing ammonia (hereinafter “condensate”) into the desalination device 2, and a condensate outflow line 4 for discharging condensate desalinated in the desalination device 2 from the desalination device 2.

The desalination device 2 is connected via an acidic aqueous solution supply line 6 to an acidic aqueous solution tank 5 for storing an acidic aqueous solution to be used in the regeneration process of the desalination device 2. In the first embodiment, the acidic aqueous solution is sulfuric acid aqueous solution with sulfuric acid as the acidic solute, but it is not limited to sulfuric acid aqueous solution, and any acidic aqueous solution can be used, such as hydrochloric acid or nitric acid aqueous solution. The pH of the acidic aqueous solution is preferably 2 or less.

Further, the desalination device 2 is connected to one end of a regeneration wastewater outflow line 7 for discharging regeneration wastewater generated by the regeneration process of the desalination device 2, and the other end of the regeneration wastewater outflow line 7 is connected to a two-chamber bipolar membrane electrodialyzer 8. The specific configuration and operation of the bipolar membrane electrodialyzer 8 will be described later. When the regeneration wastewater is electrodialyzed in the bipolar membrane electrodialyzer 8, the regeneration wastewater is separated into a regeneration acidic aqueous solution (regeneration sulfuric acid aqueous solution) containing the same acidic solute (sulfuric acid) as the acidic aqueous solution and ammonia aqueous solution. The bipolar membrane electrodialyzer 8 is connected via a regeneration acidic aqueous solution supply line 11 to the acidic aqueous solution tank 5 so that the regeneration sulfuric acid aqueous solution can be supplied to the acidic aqueous solution tank 5, and is connected via an ammonia water supply line 13 to an ammonia water storage tank 12 so that ammonia water can be supplied to the ammonia water storage tank 12.

Although not an essential component of the wastewater treatment system 1, the regeneration wastewater outflow line 7 may be provided with a concentrator 14 for concentrating an ammonium salt (ammonium sulfate) formed by reaction between sulfuric acid and ammonia in the regeneration wastewater before flowing in the bipolar membrane electrodialyzer 8. The configuration of the concentrator 14 is not particularly limited but, for example, a device with a reverse osmosis membrane or a nanofiltration membrane can be used. Further, the regeneration wastewater outflow line 7 may be provided with a device 15 including a filter for removing suspended solids or a device 16 including a chelating resin for removing iron, calcium, magnesium, etc., upstream of the concentrator 14.

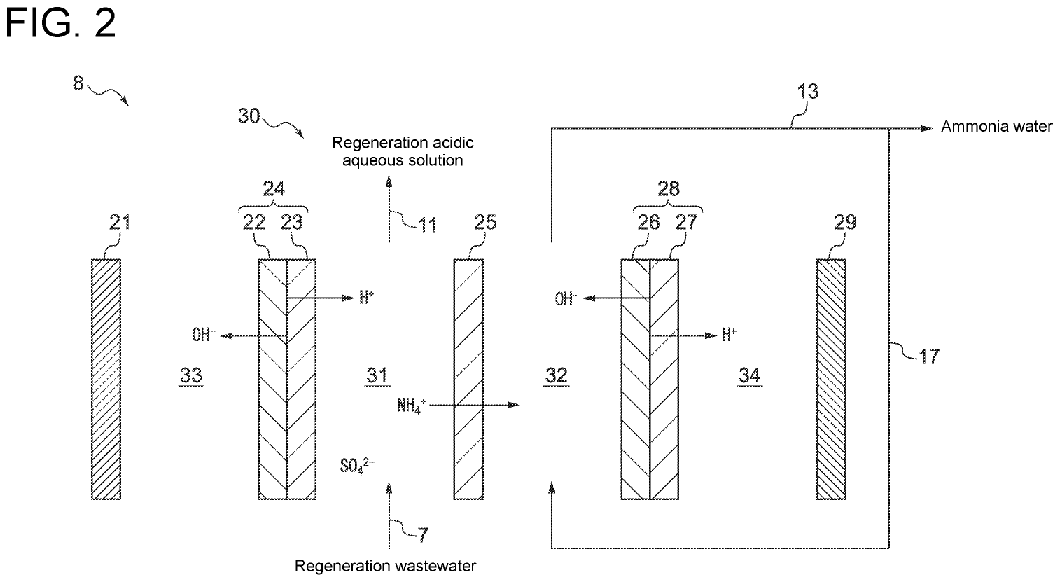

As shown in FIG. 2, the bipolar membrane electrodialyzer 8 includes an anode 21, a cathode 29, and a cell 30 disposed between the anode 21 and the cathode 29. The cell 30 includes: a first bipolar membrane 24 including a first anion exchange membrane 22 facing the anode 21 and a first cation exchange membrane 23 on the opposite side of the first anion exchange membrane 22 from the anode 21; a second cation exchange membrane 25 facing the first cation exchange membrane 23; and a second bipolar membrane 28 including a second anion exchange membrane 26 facing the second cation exchange membrane 25 and a third cation exchange membrane 27 on the opposite side of the second anion exchange membrane 26 from the second cation exchange membrane 25. A first chamber 31 is formed between the first bipolar membrane 24 and the second cation exchange membrane 25, and a second chamber 32 is formed between the second cation exchange membrane 25 and the second bipolar membrane 28. The second chamber 32 is initially filled with ammonia water. A chamber 33 formed between the anode 21 and the first bipolar membrane 24 and a chamber 34 formed between the second bipolar membrane 28 and the cathode 29 may be filled with any electrode solution. As far as the membranes facing the anode 21 and the cathode 29 are concerned, either the first anion exchange membrane 22 or the first cation exchange membrane 23, and either the second anion exchange membrane 26 or the third cation exchange membrane 27 can be used instead of the first bipolar membrane 24 and the second bipolar membrane 28, respectively, depending on the type of electrode solution.

The first chamber 31 communicates with each of the regeneration wastewater outflow line 7 and the regeneration acidic aqueous solution supply line 11. That is, the first chamber 31 is configured such that the regeneration wastewater is supplied to the first chamber 31 through the regeneration wastewater outflow line 7, and that the regeneration acidic aqueous solution is discharged from the first chamber 31 through the regeneration acidic aqueous solution supply line 11. The second chamber 32 communicates with the ammonia water supply line 13. That is, the second chamber 32 is configured such that ammonia water is discharged from the second chamber 32 through the ammonia water supply line 13. FIG. 2 is depicted such that the regeneration acidic aqueous solution and ammonia water are directly discharged from the first chamber 31 and the second chamber 32, respectively, but the present disclosure is not limited to this embodiment. Recycle lines may be provided such that the solution is partially extracted from each of the first chamber 31 and the second chamber 32 and returned to each of the first chamber 31 and the second chamber 32, and the regeneration acidic aqueous solution supply line 11 and the ammonia water supply line 13 may be connected to the respective recycle lines. Further, an ammonia water return line 17 branches off from the ammonia water supply line 13, and the ammonia water return line 17 is connected to the second chamber 32. That is, it is configured such that part of ammonia water flowing through the ammonia water supply line 13 is supplied to the second chamber 32 through the ammonia water return line 17.

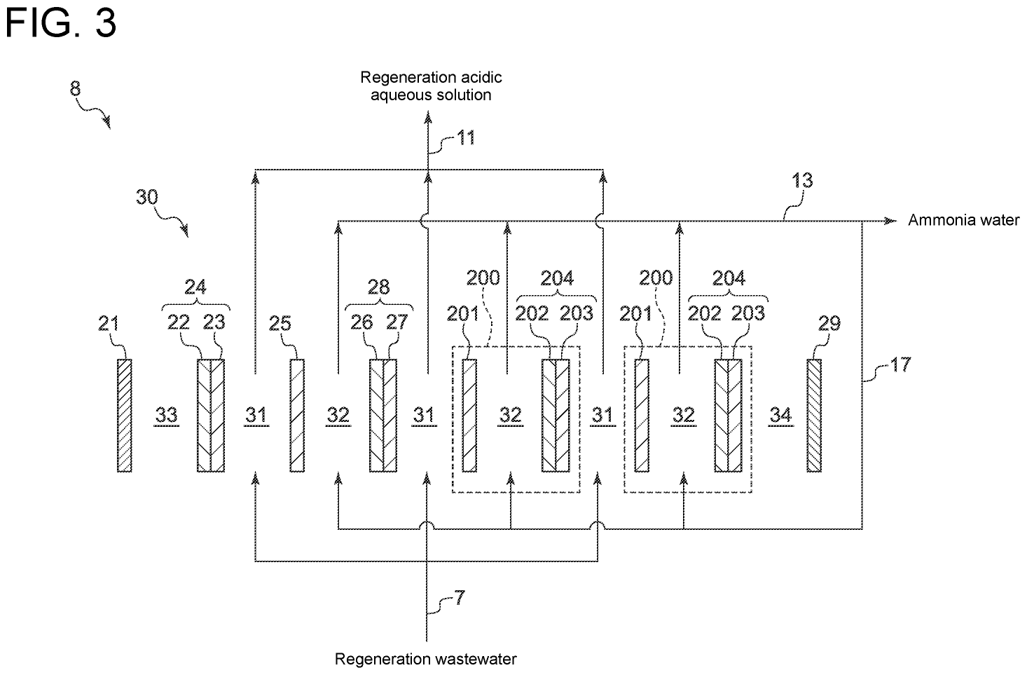

As shown in FIG. 3, the cell 30 may include, between the second bipolar membrane 28 and the cathode 29, a repeating unit 200 that includes: a fourth cation exchange membrane 201 facing the third cation exchange membrane 27; and a third bipolar membrane 204 including a third anion exchange membrane 202 facing the fourth cation exchange membrane 201 and a fifth cation exchange membrane 203. Although FIG. 3 shows a configuration in which the cell 30 has two repeating units 200, it is not limited to this embodiment. The cell 30 may have one repeating unit 200 or any number of repeating units 200, three or more.

When the cell 30 has one repeating unit 200, the first chamber 31 is formed by the second bipolar membrane 28 and the fourth cation exchange membrane 201, and the second chamber 32 is formed by the fourth cation exchange membrane 201 and the third bipolar membrane 204. When the cell 30 has two or more repeating units 200, the first chamber 31 is also formed by the third bipolar membrane 204 of one of two adjacent repeating units 200, 200 and the fourth cation exchange membrane 201 of the other of the two adjacent repeating units 200, 200, and the second chamber 32 is formed by the fourth cation exchange membrane 201 and the third bipolar membrane 204 in each repeating unit 200.

### <Operation of Wastewater Treatment System According to First Embodiment of Present Disclosure>

Next, the operation of the wastewater treatment system 1 according to the first embodiment of the present disclosure will be described. As shown in FIG. 1, when the condensate flowing through the condensate inflow line 3 enters the desalination device 2, ammonium ions are exchanged with cations in the cation exchange resin 2a, and ammonia in the condensate is captured by the desalination device 2. Since ammonia is removed from the condensate, condensate with a reduced ammonia concentration is discharged from the desalination device 2 through the condensate outflow line 4.

As the desalination of condensate by the desalination device 2 continues, the amount of ammonia captured by the desalination device 2 increases, creating the need for a regeneration process of the desalination device 2. To regenerate the desalination device 2, sulfuric acid aqueous solution is supplied to the desalination device 2 from the acidic aqueous solution tank 5 through the acidic aqueous solution supply line 6. When sulfuric acid aqueous solution is supplied to the desalination device 2, ammonium ions captured by the cation exchange resin are exchanged with hydrogen ions. This results in the formation of ammonium sulfate (actually, sulfate ions and ammonium ions). The regeneration wastewater discharged from the desalination device 2 through the regeneration wastewater outflow line 7 contains sulfuric acid and ammonium sulfate. The regeneration wastewater flowing through the regeneration wastewater outflow line 7 is supplied to the bipolar membrane electrodialyzer 8.

As shown in FIG. 2, the regeneration wastewater flows into the first chamber 31 of the bipolar membrane electrodialyzer 8. By applying a current between the anode 21 and the cathode 29, the regeneration wastewater is electrodialyzed. Ammonium ions in the regeneration wastewater flowing in the first chamber 31 are attracted to the cathode 29 and flow through the second cation exchange membrane 25 into the second chamber 32. In the first bipolar membrane 24, water is absorbed into the membrane by absorption and dissociates into hydrogen ions and hydroxide ions at the boundary between the first anion exchange membrane 22 and the first cation exchange membrane 23. Hydrogen ions thus generated flow through the first cation exchange membrane 23 into the first chamber 31, while hydroxide ions flow through the first anion exchange membrane 22 into the chamber 33. Similarly, in the second bipolar membrane 28, water dissociates into hydrogen ions and hydroxide ions at the boundary between the second anion exchange membrane 26 and the third cation exchange membrane 27. Hydroxide ions thus generated flow through the second anion exchange membrane 26 into the second chamber 32, while hydrogen ions flow through the third cation exchange membrane 27 into the chamber 34.

Since ammonium ions in the first chamber 31 move to the second chamber 32, and hydrogen ions flow from the first bipolar membrane 24 to the first chamber 31, the concentration of ammonium sulfate in the regeneration wastewater flowing in the first chamber 31 decreases, and the concentration of sulfuric acid increases. As a result, regeneration sulfuric acid aqueous solution with a higher concentration of sulfuric acid than the regeneration wastewater flowing in the first chamber 31 is discharged from the first chamber 31. In the second chamber 32, since ammonium ions move from the first chamber 31, the concentration of ammonium ions in water in the second chamber 32 increases. As a result, ammonia water is discharged from the second chamber 32. When part of the ammonia water discharged from the second chamber 32 continues to be supplied to the second chamber 32 through the ammonia water return line 17, the second chamber 32 continues to be filled with an ionic aqueous solution (specifically, a solution containing ammonium ions and hydroxide ions), so that when a current is applied between the anode 21 and the cathode 29, a current continues to flow in the second chamber 32, and the above operation continues.

As shown in FIG. 1, the regeneration sulfuric acid aqueous solution discharged from the first chamber 31 is supplied to the acidic aqueous solution tank 5 through the regeneration acidic aqueous solution supply line 11 and reused as at least part of the acidic aqueous solution in the regeneration process of the desalination device 2. The ammonia water discharged from the second chamber 32 is supplied to the ammonia water storage tank 12 through the ammonia water supply line 13 and used for a boiler, a denitration device, etc. (not shown).

Thus, by separating a regeneration acidic aqueous solution from regeneration wastewater generated by regenerating the desalination device 2 with an acidic aqueous solution, and reusing the regeneration acidic aqueous solution as at least part of the acidic aqueous solution for regeneration of the desalination device 2, the consumption of the acidic aqueous solution can be reduced, so that the cost of the regeneration process of the desalination device 2 can be reduced.

In the first embodiment, if a concentrator 14 is provided on the regeneration wastewater outflow line 7, ammonium sulfate is concentrated in the concentrator 14 before the regeneration wastewater flows into the bipolar membrane electrodialyzer 8. The regeneration wastewater with concentrated ammonium sulfate flows into the bipolar membrane electrodialyzer 8, and the component separated from the regeneration wastewater in the concentrator 14, mainly water, are reused in the plant where the wastewater treatment system 1 is installed. This component may be reused as the acidic aqueous solution if the pH is low.

If the concentration of ammonium salt in the regeneration wastewater is low, the separation efficiency of regeneration acidic aqueous solution by electrodialysis decreases. In contrast, by providing the concentrator 14 on the regeneration wastewater outflow line 7, electrodialysis can be performed on the regeneration wastewater with a higher concentration of ammonium salt, so that the separation efficiency of regeneration acidic aqueous solution by electrodialysis can be improved.

Further, by providing a device 15, 16 on the regeneration wastewater outflow line 7, the concentration of suspended solids and multivalent cations such as iron ions, calcium ions, and magnesium ions in the regeneration wastewater can be reduced. As a result, in the regeneration wastewater flowing in the bipolar membrane electrodialyzer 8, the concentration of components other than ammonium sulfate can be further reduced, so that the separation efficiency of regeneration acidic aqueous solution by electrodialysis can be further improved.

### Second Embodiment

Next, the wastewater treatment system according to the second embodiment will be described. In the wastewater treatment system according to the second embodiment, an ammonia stripper for removing ammonia from the regeneration wastewater is added to the first embodiment. In the second embodiment, the same constituent element as those in the first embodiment are associated with the same reference numerals and not described again in detail.

### <Configuration of Wastewater Treatment System According to Second Embodiment of Present Disclosure>

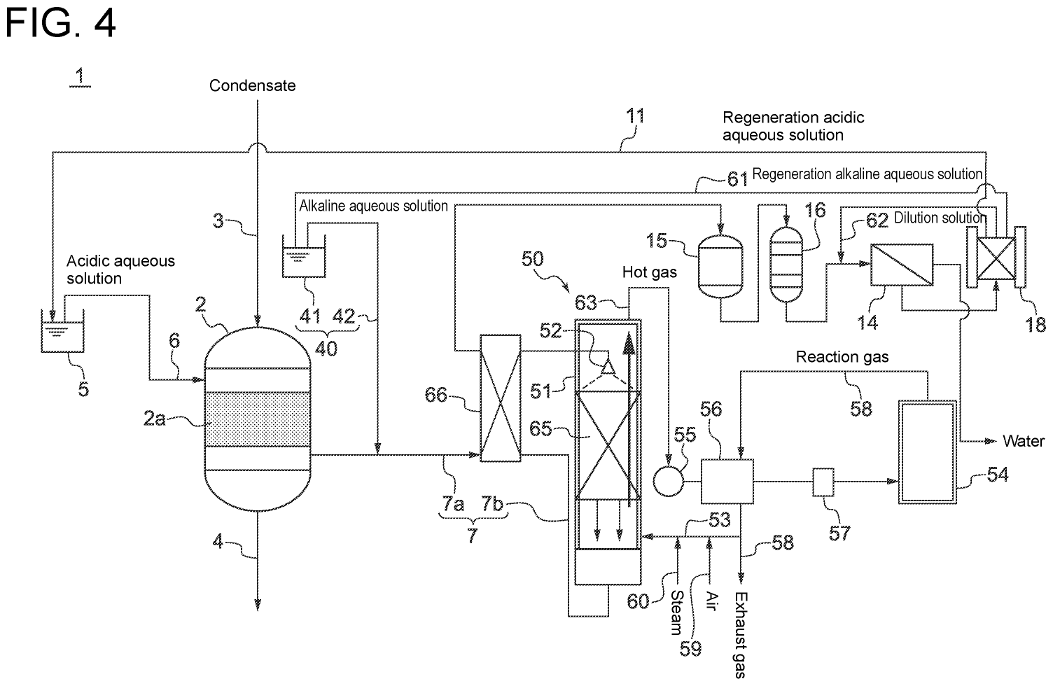

As shown in FIG. 4, the wastewater treatment system 1 according to the first embodiment of the present disclosure includes a supply device 40 for supplying sodium hydroxide aqueous solution as an alkaline aqueous solution to the regeneration wastewater flowing through the regeneration wastewater outflow line 7, and an ammonia stripper 50 for separating ammonia from the regeneration wastewater supplied with the sodium hydroxide aqueous solution. A three-chamber bipolar membrane electrodialyzer 18 is connected to the downstream end of the regeneration wastewater outflow line 7, unlike the first embodiment. In the second embodiment, sodium hydroxide aqueous solution is used as the alkaline aqueous solution, but it is not limited to sodium hydroxide aqueous solution, and an aqueous solution that contains a hydroxide of any alkali metal as the solute can be used. The pH of the alkaline aqueous solution is preferably 11 or more.

The supply device 40 includes an alkaline aqueous solution tank 41 for storing sodium hydroxide aqueous solution, and an alkaline aqueous solution supply line 42 connected at one end to the alkaline aqueous solution tank 41 and at the other end to the regeneration wastewater outflow line 7 upstream of the ammonia stripper 50.

The ammonia stripper 50 has a housing 51 extending in the vertical direction. In the housing 51, a release portion 52 is provided on the regeneration wastewater outflow line 7 for releasing the regeneration wastewater downward in the vertical direction. Further, the housing 51 is connected to one end of a hot gas supply line 53 for supplying hot gas containing steam into the housing 51 at a position lower than the release portion 52. The operation of the ammonia stripper 50 will be described later. In the housing 51, the regeneration wastewater falling downward from the release portion 52 comes into contact with the hot gas that is supplied into the housing 51 through the hot gas supply line 53 and rises. The top of the housing 51 is connected to one end of an outflow line 63 to allow the hot gas rising in the housing 51 to flow out of the housing 51. The regeneration wastewater outflow line 7 consists of an upstream regeneration wastewater outflow line 7a extending from the desalination device 2 to the release portion 52 and a downstream regeneration wastewater outflow line 7b extending from the bottom of the housing 51 to the bipolar membrane electrodialyzer 18, and the downstream regeneration wastewater outflow line 7b is connected to the bottom of the housing 51. The housing 51 may contain a packing material 65, such as Raschig rings, or one or more plates at the position where the regeneration wastewater and hot air come into contact with each other.

The regeneration wastewater outflow line 7 may be provided with a heat exchanger 66 for exchanging heat between the regeneration wastewater flowing through the upstream regeneration wastewater outflow line 7a and a waste solution from the ammonia stripper 50 flowing through the downstream regeneration wastewater outflow line 7b. In the second embodiment, as in the first embodiment, a concentrator 14 and devices 15, 16 may be provided on the downstream regeneration wastewater outflow line 7b.

The other end of the outflow line 63 is connected to a catalyst tower 54 filled with a catalyst for burning ammonia in a reducing atmosphere. Between the housing 51 and the catalyst tower 54, an air blower 55, a heat exchanger 56, and a heater 57 are provided on the outflow line 63. The top of the catalyst tower 54 is connected to a reaction gas outflow line 58 for discharging a reaction gas containing nitrogen and water produced by burning ammonia in a reducing atmosphere. The heat exchanger 56 is configured to exchange heat between the hot gas flowing through the outflow line 63 and the reaction gas flowing through the reaction gas outflow line 58. The reaction gas outflow line 58 is connected to the other end of the hot gas supply line 53 downstream of the heat exchanger 56. This configuration allows part of the reaction gas that has passed through the heat exchanger 56 to flow into the hot gas supply line 53. To the hot gas supply line 53 is connected an air supply line 59 for supplying air to the reaction gas flowing through the hot gas supply line 53 and a steam supply line 60 for supplying steam to the reaction gas flowing through the hot gas supply line 53.

The specific configuration and operation of the bipolar membrane electrodialyzer 18 will be described later. When the waste solution from the ammonia stripper 50, which is a solution derived from the regeneration wastewater, is electrodialyzed in the bipolar membrane electrodialyzer 18, the waste solution is separated into a regeneration sulfuric acid aqueous solution, a regeneration alkaline aqueous solution containing sodium hydroxide as the solute, and a dilution solution. The bipolar membrane electrodialyzer 18 is connected via the regeneration acidic aqueous solution supply line 11 to the acidic aqueous solution tank 5 so that the regeneration sulfuric acid aqueous solution can be supplied to the acidic aqueous solution tank 5, is connected via a regeneration alkaline aqueous solution supply line 61 to the alkaline aqueous solution tank 41 so that the regeneration alkaline aqueous solution can be supplied to the alkaline aqueous solution tank 41, and is connected via a dilution solution return line 62 to the downstream regeneration wastewater outflow line 7b between the device 16 and the concentrator 14 so that the dilution solution can be supplied to the waste solution before flowing in the concentrator 14. Other configurations are the same as those in the first embodiment, except for the configuration of the bipolar membrane electrodialyzer 18 which will be described next.

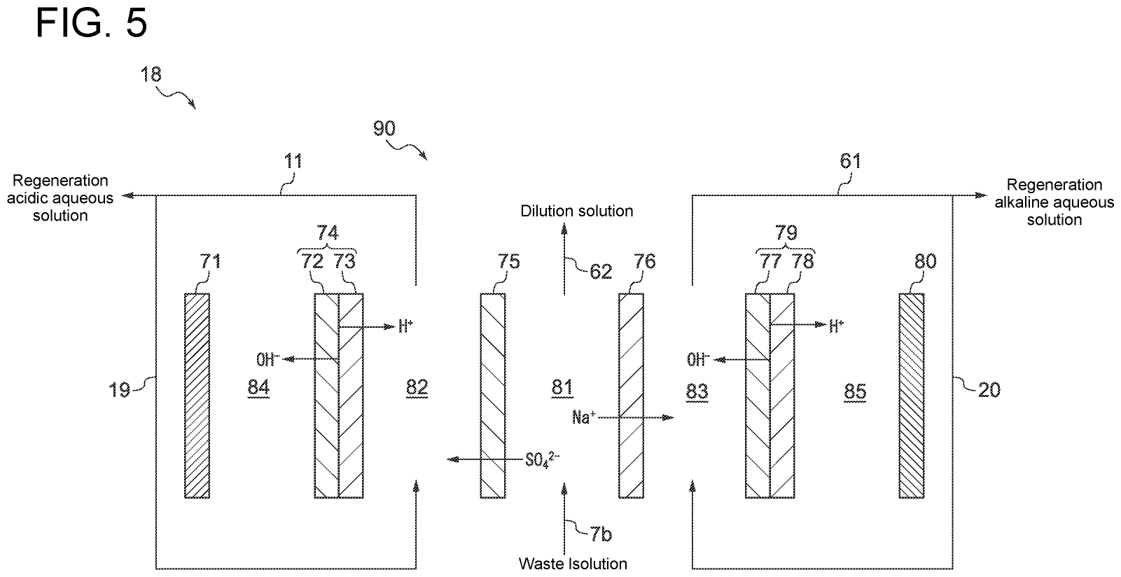

As shown in FIG. 5, the bipolar membrane electrodialyzer 18 includes an anode 71, a cathode 80, and a cell 90 disposed between the anode 71 and the cathode 80. The cell 90 includes: a first bipolar membrane 74 including a first anion exchange membrane 72 facing the anode 71 and a first cation exchange membrane 73 on the opposite side of the first anion exchange membrane 72 from the anode 71; a second anion exchange membrane 75 facing the first cation exchange membrane 73; a second cation exchange membrane 76 facing the first anion exchange membrane 75; and a second bipolar membrane 79 including a third anion exchange membrane 77 facing the second cation exchange membrane 76 and a third cation exchange membrane 78 on the opposite side of the third anion exchange membrane 77 from the second cation exchange membrane 76. A first chamber 81 is formed between the second anion exchange membrane 75 and the second cation exchange membrane 76, a second chamber 82 is formed between the first bipolar membrane 74 and the second anion exchange membrane 75, and a third chamber 83 is formed between the second cation exchange membrane 76 and the second bipolar membrane 79. The second chamber 82 is initially filled with sulfuric acid aqueous solution, and the third chamber 83 is initially filled with sodium hydroxide aqueous solution. A chamber 84 formed between the anode 71 and the first bipolar membrane 74 and a chamber 85 formed between the second bipolar membrane 79 and the cathode 80 may be filled with any electrode solution. As far as the membranes facing the anode 71 and the cathode 80 are concerned, either the first anion exchange membrane 72 or the first cation exchange membrane 73, and either the third anion exchange membrane 77 or the third cation exchange membrane 78 can be used instead of the first bipolar membrane 74 and the second bipolar membrane 79, respectively, depending on the type of electrode solution.

The first chamber 81 communicates with each of the downstream regeneration wastewater outflow line 7b and the dilution solution return line 62. That is, the first chamber 81 is configured such that the waste solution from the ammonia stripper 50 (see FIG. 4) is supplied to the first chamber 81 through the downstream regeneration wastewater outflow line 7b, and that the dilution solution is discharged from the first chamber 81 through the dilution solution return line 62. The second chamber 82 communicates with the regeneration acidic aqueous solution supply line 11. That is, the second chamber 82 is configured such that the regeneration acidic aqueous solution is discharged from the second chamber 82 through the regeneration acidic aqueous solution supply line 11. The third chamber 83 communicates with the regeneration alkaline aqueous solution supply line 61. That is, the third chamber 83 is configured such that the regeneration alkaline aqueous solution is discharged from the third chamber 83 through the regeneration alkaline aqueous solution supply line 61. Further, a regeneration acidic aqueous solution return line 19 branches off from the regeneration acidic aqueous solution supply line 11, and the regeneration acidic aqueous solution return line 19 is connected to the second chamber 82. That is, it is configured such that part of regeneration acidic aqueous solution flowing through the regeneration acidic aqueous solution supply line 11 is supplied to the second chamber 82 through the regeneration acidic aqueous solution return line 19. A regeneration alkaline aqueous solution return line 20 branches off from the regeneration alkaline aqueous solution supply line 61, and the regeneration alkaline aqueous solution return line 20 is connected to the third chamber 83. That is, it is configured such that part of regeneration alkaline aqueous solution flowing through the regeneration alkaline aqueous solution supply line 61 is supplied to the third chamber 83 through the regeneration alkaline aqueous solution return line 20.

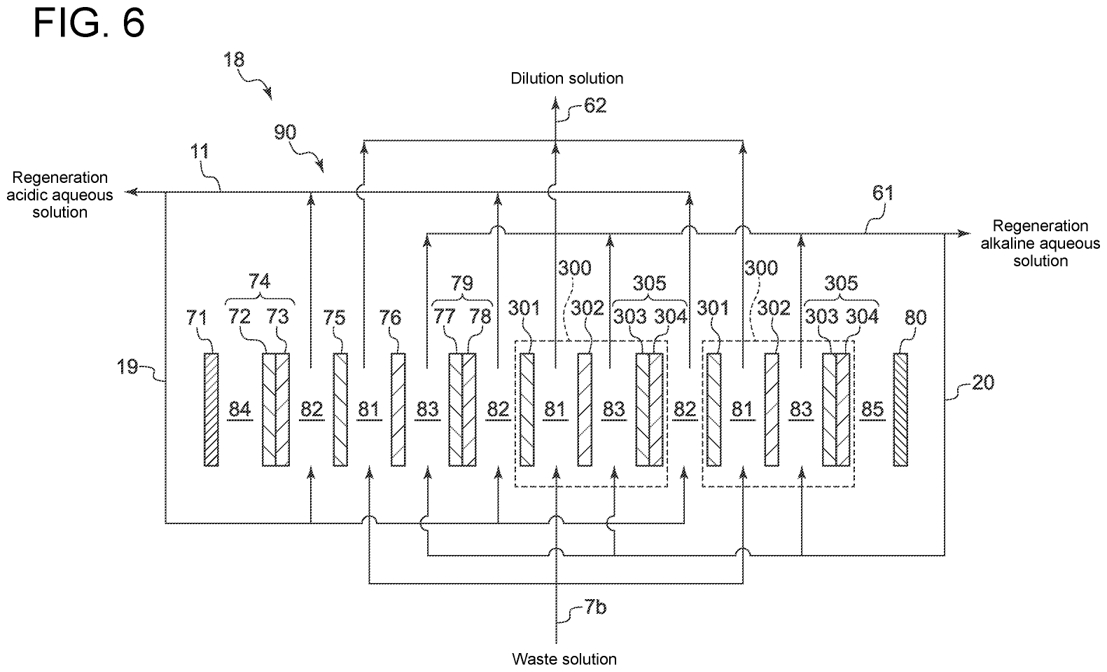

As shown in FIG. 6, the cell 90 may include, between the second bipolar membrane 79 and the cathode 80, a repeating unit 300 that includes: a fourth anion exchange membrane 301 facing the third cation exchange membrane 78, a fourth cation exchange membrane 302 facing the fourth anion exchange membrane 301; and a third bipolar membrane 305 including a fifth anion exchange membrane 303 facing the fourth cation exchange membrane 302 and a fifth cation exchange membrane 304. Although FIG. 6 shows a configuration in which the cell 90 has two repeating units 300, it is not limited to this embodiment. The cell 90 may have one repeating unit 300 or any number of repeating units 300, three or more.

When the cell 90 has one repeating unit 300, the first chamber 81 is formed by the fourth anion exchange membrane 301 and the fourth cation exchange membrane 302, the second chamber 82 is formed by the second bipolar membrane 79 and the fourth anion exchange membrane 301, and the third chamber 83 is formed by the fourth cation exchange membrane 302 and the third bipolar membrane 305. When the cell 90 has two or more repeating units 300, the first chamber 81 is formed by the fourth anion exchange membrane 301 and the fourth cation exchange membrane 302 in each repeating unit 300, the second chamber 82 is also formed by the third bipolar membrane 305 of one of two adjacent repeating units 300, 300 and the fourth anion exchange membrane 301 of the other of the two adjacent repeating units 300, 300, and the third chamber 83 is formed by the fourth cation exchange membrane 302 and the third bipolar membrane 305 in each repeating unit 300.

### <Operation of Wastewater Treatment System According to Second Embodiment of Present Disclosure>

Next, the operation of the wastewater treatment system 1 according to the second embodiment of the present disclosure will be described. Since the operation of the second embodiment differs from that of the first embodiment in the treatment operation of regeneration wastewater of the desalination device 2, only the treatment operation of regeneration wastewater of the desalination device 2 will be described below. As shown in FIG. 4, sodium hydroxide aqueous solution is supplied from the alkaline aqueous solution tank 41 through the alkaline aqueous solution supply line 42 to the regeneration wastewater discharged from the desalination device 2. When sodium hydroxide aqueous solution is supplied to the regeneration wastewater, the pH of the regeneration wastewater increases. As the pH increases, the percentage of ammonia in the regeneration wastewater in the form of free ammonia, rather than in the form of ammonium ions increases. This can be described by the following reaction equation.

(NH₄)₂SO₄+2NaOH→Na₂SO₄+2H₂O+2NH₃

Compared to ammonium ions, free ammonia tends to dissipate more readily from water when the aqueous solution is heated.

The regeneration wastewater supplied with sodium hydroxide aqueous solution is heated in the heat exchanger 66 by heat exchange with the waste solution from the ammonia stripper 50, which will be described below, and is then released from the release portion 52 into the housing 51 and falls within the housing 51. The housing 51 is also supplied with hot via the hot gas supply line 53, and the hot rises within the housing 51. In the housing 51, the regeneration wastewater is heated by contact between the falling regeneration wastewater and the rising hot gas, and mainly free ammonia is dissipated from the regeneration wastewater. The ammonia dissipated from the regeneration wastewater is mixed with the hot gas as ammonia gas, and the ammonia gas is discharged from the top of the housing 51 and flows through the outflow line 63.

The hot gas flowing through the outflow line 63 is blown by the blower 55, heated by passing through the heat exchanger 56 and the heater 57 sequentially, and then flows into the catalyst tower 54. In the catalyst tower 54, ammonia is burned in a reducing atmosphere to produce a reaction gas containing mainly nitrogen and water. The reaction gas discharged from the catalyst tower 54 flows through the reaction gas outflow line 58 and is cooled by heat exchange with the hot gas in the heat exchanger 56. Part of the cooled reaction gas flows into the hot gas supply line 53, and the remainder is exhausted into the atmosphere. The reaction gas flowing into the hot gas supply line 53 is supplied with air and steam via the air supply line 59 and the steam supply line 60, respectively, and is supplied into the housing 51 as the hot gas. Since ammonia is dissipated from the regeneration wastewater falling within the housing 51 by the operation described above, the regeneration wastewater at the bottom of the housing 51 has a lower concentration of ammonia than the regeneration wastewater released from the release portion 52, and is mainly an aqueous solution in which sodium sulfate is dissolved. This aqueous solution is discharged from the bottom of the housing 51 as the waste solution from the ammonia stripper 50 and flows through the downstream regeneration wastewater outflow line 7b. The waste solution flowing through the downstream regeneration wastewater outflow line 7b is then cooled by heat exchange with the regeneration wastewater in the heat exchanger 66, and is supplied to the bipolar membrane electrodialyzer 18.

As shown in FIG. 5, the waste solution flows into the first chamber 81 of the bipolar membrane electrodialyzer 18. By applying a current between the anode 71 and the cathode 80, the waste solution is electrodialyzed. Sulfate ions in the waste solution flowing in the first chamber 81 are attracted to the anode 71 and flow through the second anion exchange membrane 75 into the second chamber 82. In the first bipolar membrane 74, water is absorbed into the membrane by absorption and dissociates into hydrogen ions and hydroxide ions at the boundary between the first anion exchange membrane 72 and the first cation exchange membrane 73. Hydrogen ions thus generated flow through the first cation exchange membrane 73 into the second chamber 82, while hydroxide ions flow through the first anion exchange membrane 72 into the chamber 84. Sodium ions in the waste solution flowing in the first chamber 81 are attracted to the cathode 80 and flow through the second cation exchange membrane 76 into the third chamber 83. In the second bipolar membrane 79, water is absorbed into the membrane by absorption and dissociates into hydrogen ions and hydroxide ions at the boundary between the third anion exchange membrane 77 and the third cation exchange membrane 78. Hydroxide ions thus generated flow through the third anion exchange membrane 77 into the third chamber 83, while hydrogen ions flow through the third cation exchange membrane 78 into the chamber 85.

Since sulfate ions in the first chamber 81 move to the second chamber 82, and sodium ions move to the third chamber 38, the concentration of sodium sulfate in the waste solution flowing in the first chamber 81 decreases. As a result, a dilution solution with a lower concentration of sodium sulfate than the waste solution flowing in the first chamber 81 is discharged from the first chamber 81, and the dilution solution is returned to the downstream regeneration wastewater outflow line 7b through the dilution solution return line 62.

Sulfate ions that move from the first chamber 81 to the second chamber 82 react with hydrogen ions that move from the first bipolar membrane 74 to the second chamber 82 to form sulfuric acid, thereby turning the aqueous solution in the second chamber 82 into sulfuric acid aqueous solution. From the second chamber 82, the sulfuric acid aqueous solution is discharged as the regeneration acidic aqueous solution. The regeneration acidic aqueous solution is supplied to the acidic aqueous solution tank 5 through the regeneration acidic aqueous solution supply line 11 and reused in the regeneration process of the desalination device 2. When part of the regeneration acidic aqueous solution discharged from the second chamber 82 continues to be supplied to the second chamber 82 through the regeneration acidic aqueous solution return line 19, the second chamber 82 continues to be filled with an ionic aqueous solution (specifically, a solution containing sulfate ions and hydrogen ions), so that when a current is applied between the anode 71 and the cathode 80, a current continues to flow in the second chamber 82, and the above operation continues.

Sodium ions that move from the first chamber 81 to the third chamber 83 react with hydroxide ions that move from the second bipolar membrane 79 to the third chamber 83 to form sodium hydroxide, thereby turning the aqueous solution in the third chamber 83 into sodium hydroxide aqueous solution. From the third chamber 83, the sodium hydroxide aqueous solution is discharged as the regeneration alkaline aqueous solution. The regeneration alkaline aqueous solution is supplied to the alkaline aqueous solution tank 41 through the regeneration alkaline aqueous solution supply line 61 and reused in the treatment of the regeneration wastewater generated by the regeneration process of the desalination device 2. When part of the regeneration alkaline aqueous solution discharged from the third chamber 83 continues to be supplied to the third chamber 83 through the regeneration alkaline aqueous solution return line 20, the third chamber 83 continues to be filled with an ionic aqueous solution (specifically, a solution containing sodium ions and hydroxide ions), so that when a current is applied between the anode 71 and the cathode 80, a current continues to flow in the third chamber 83, and the above operation continues.

The operation and effect obtained when the concentrator 14 is provided on the downstream regeneration wastewater outflow line 7b and when the devices 15 and 16 are further provided are basically the same as in the first embodiment. However, if the concentrator 14 is not provided in the second embodiment, a dilution solution separated by the bipolar membrane electrodialyzer 18 and returned to the downstream regeneration wastewater outflow line 7b may dilute the waste solution flowing in the bipolar membrane electrodialyzer 18, which reduces the efficiency of electrodialysis. Therefore, the dilution solution must be disposed of. In contrast, by providing the concentrator 14, the dilution solution and the waste solution can be concentrated together and then electrodialyzed again. Thus, the separation amount of the regeneration acidic aqueous solution and the regeneration alkaline aqueous solution can be increased compared to the case without the concentrator 14.

Thus, by supplying an alkaline aqueous solution to regeneration wastewater generated by regenerating the desalination device 2 with an acidic aqueous solution to separate ammonia by the ammonia stripper 50, separating a regeneration acidic aqueous solution and a regeneration alkaline aqueous solution from a waste solution from the ammonia stripper 50, and reusing the regeneration acidic aqueous solution as at least part of the acidic aqueous solution for regeneration of the desalination device 2 while supplying the regeneration alkaline aqueous solution to the regeneration wastewater as at least part of the alkaline aqueous solution, the consumption of the acidic aqueous solution and the alkaline aqueous solution can be reduced, so that the cost of the regeneration process of the desalination device 2 can be reduced.

### <Modification of Wastewater Treatment System of Present Disclosure>

In the first embodiment, a two-chamber bipolar membrane electrodialyzer 8 is used, but a three-chamber bipolar membrane electrodialyzer 18 used in the wastewater treatment system 1 according to the second embodiment can also be used. The following describes a modification of the first embodiment in which a three-chamber bipolar membrane electrodialyzer 18 is used.

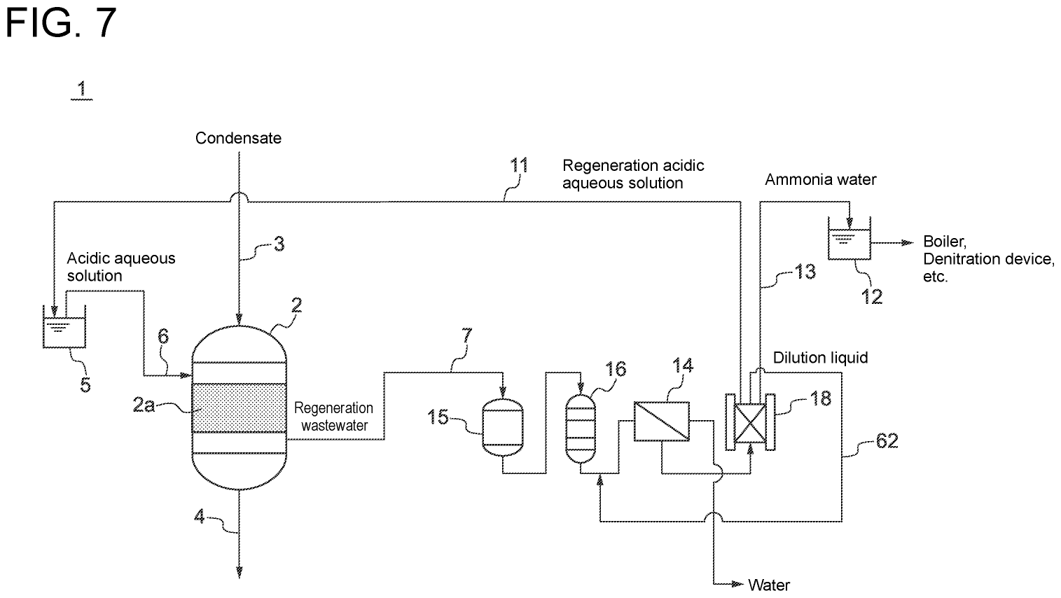

As shown in FIG. 7, the bipolar membrane electrodialyzer 18 is connected via the regeneration acidic aqueous solution supply line 11 and the ammonia water supply line 13 to the acidic aqueous solution tank 5 and the ammonia water storage tank 12, respectively. Further, the bipolar membrane electrodialyzer 18 is connected via the dilution solution return line 62 to the regeneration wastewater outflow line 7 between the device 16 and the concentrator 14 so that the dilution solution can be supplied to the regeneration wastewater before flowing in the concentrator 14.

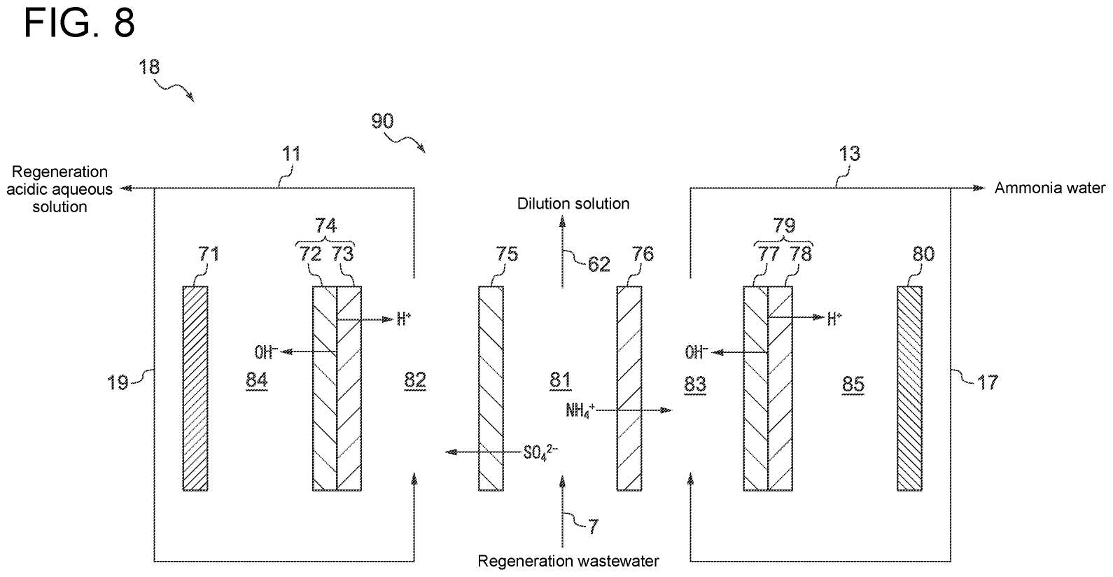

As shown in FIG. 8, the first chamber 81 communicates with each of the regeneration wastewater outflow line 7 and the dilution solution return line 62. That is, the first chamber 81 is configured such that the regeneration wastewater is supplied to the first chamber 81 through the regeneration wastewater outflow line 7, and that the dilution solution is discharged from the first chamber 81 through the dilution solution return line 62. The second chamber 82 communicates with the regeneration acidic aqueous solution supply line 11. That is, the second chamber 82 is configured such that the regeneration acidic aqueous solution is discharged from the second chamber 82 through the regeneration acidic aqueous solution supply line 11. The third chamber 83 communicates with the ammonia water supply line 13. That is, the third chamber 83 is configured such that ammonia water is discharged from the third chamber 83 through the ammonia water supply line 13. The second chamber 82 is initially filled with sulfuric acid aqueous solution, and the third chamber 83 is initially filled with ammonia water. Further, a regeneration acidic aqueous solution return line 19 branches off from the regeneration acidic aqueous solution supply line 11, and the regeneration acidic aqueous solution return line 19 is connected to the second chamber 82. That is, it is configured such that part of regeneration acidic aqueous solution flowing through the regeneration acidic aqueous solution supply line 11 is supplied to the second chamber 82 through the regeneration acidic aqueous solution return line 19. An ammonia water return line 17 branches off from the ammonia water supply line 13, and the ammonia water return line 17 is connected to the third chamber 83. That is, it is configured such that part of ammonia water flowing through the ammonia water supply line 13 is supplied to the third chamber 83 through the ammonia water return line 17.

The regeneration wastewater flows into the first chamber 81 of the bipolar membrane electrodialyzer 18. By applying a current between the anode 71 and the cathode 80, the regeneration wastewater is electrodialyzed. Sulfate ions in the regeneration wastewater flowing in the first chamber 81 are attracted to the anode 71 and flow through the second anion exchange membrane 75 into the second chamber 82. In the first bipolar membrane 74, water is absorbed into the membrane by absorption and dissociates into hydrogen ions and hydroxide ions at the boundary between the first anion exchange membrane 72 and the first cation exchange membrane 73. Hydrogen ions thus generated flow through the first cation exchange membrane 73 into the second chamber 82, while hydroxide ions flow through the first anion exchange membrane 72 into the chamber 84. Ammonium ions in the regeneration wastewater flowing in the first chamber 81 are attracted to the cathode 80 and flow through the second cation exchange membrane 76 into the third chamber 83. In the second bipolar membrane 79, water is absorbed into the membrane by absorption and dissociates into hydrogen ions and hydroxide ions at the boundary between the third anion exchange membrane 77 and the third cation exchange membrane 78. Hydroxide ions thus generated flow through the third anion exchange membrane 77 into the third chamber 83, while hydrogen ions flow through the third cation exchange membrane 78 into the chamber 85.

Since sulfate ions in the first chamber 81 move to the second chamber 82, and ammonium ions move to the third chamber 83, the concentration of ammonium sulfate in the regeneration wastewater flowing in the first chamber 81 decreases. As a result, a dilution solution with a lower concentration of ammonium sulfate than the regeneration wastewater flowing in the first chamber 81 is discharged from the first chamber 81, and the dilution solution is returned to the regeneration wastewater outflow line 7 through the dilution solution return line 62.

The operation of producing a regeneration acidic aqueous solution in the second chamber 82 6 is the same as in the second embodiment. In the third chamber 83, since ammonium ions move from the first chamber 81, the concentration of ammonium ions in water in the third chamber 83 increases. As a result, ammonia water is discharged from the third chamber 83. Part of ammonia water discharged from the third chamber 83 and flowing through the ammonia water supply line 13 is supplied to the third chamber 83 through the ammonia water return line 17.

In this modification, as in the first embodiment, by separating a regeneration acidic aqueous solution from regeneration wastewater of the desalination device 2, and reusing the regeneration acidic aqueous solution as at least part of the acidic aqueous solution for regeneration of the desalination device 2, the consumption of the acidic aqueous solution can be reduced, so that the cost of the regeneration process of the desalination device 2 can be reduced. Additionally, since the dilution solution and the regeneration wastewater can be concentrated together and then electrodialyzed again, the separation amount of the regeneration acidic aqueous solution and ammonia water can be increased.

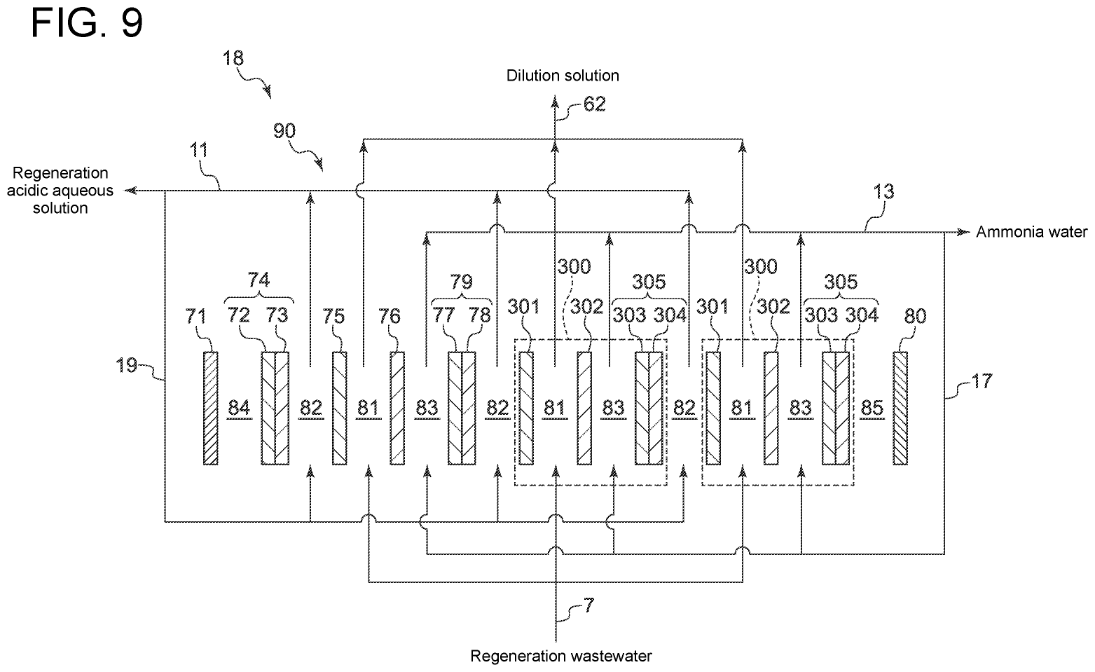

In this modification, as shown in FIG. 9, the cell 90 may include at least one repeating unit 300 between the second bipolar membrane 79 and the cathode 80. The configuration of the repeating unit 300 and the respective positions where the first chamber 81, the second chamber 82, and the third chamber 83 are formed when the cell 90 includes the repeating unit 300 are the same as those shown in FIG. 6.

Further, in the first embodiment, an alternative form of two-chamber bipolar membrane electrodialyzer, which will be described below, may be provided instead of the bipolar membrane electrodialyzer 8 in the configuration of the wastewater treatment system 1 shown in FIG. 1.

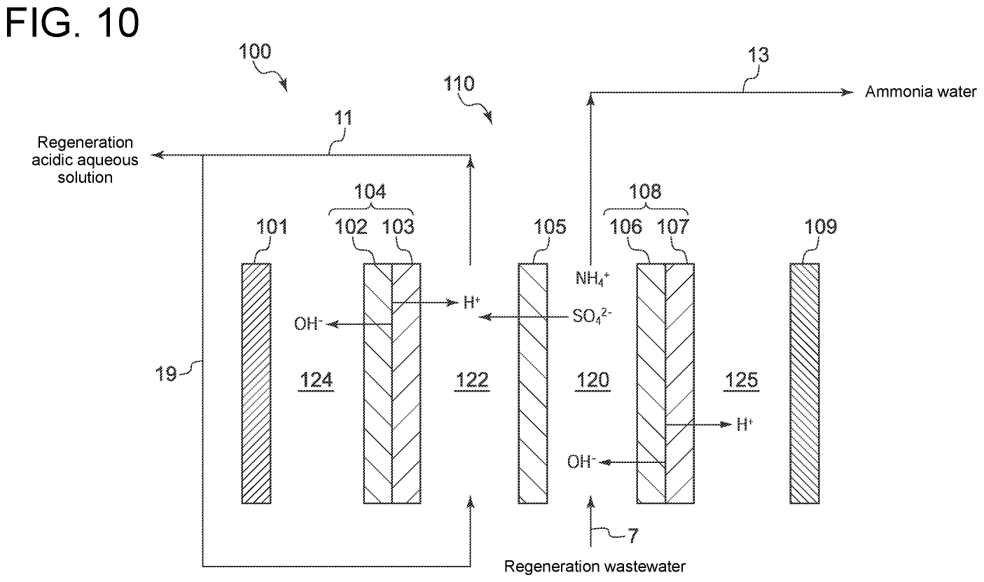

As shown in FIG. 10, this alternative form of two-chamber bipolar membrane electrodialyzer 100 includes an anode 101, a cathode 113, and a cell 110 disposed between the anode 101 and the cathode 109. The cell 110 includes: a first bipolar membrane 104 including a first anion exchange membrane 102 facing the anode 101 and a first cation exchange membrane 103; a second anion exchange membrane 105 facing the first cation exchange membrane 103; and a second bipolar membrane 108 including a third anion exchange membrane 106 facing the second anion exchange membrane 105 and a second cation exchange membrane 107. A first chamber 120 is formed by the second anion exchange membrane 105 and the third anion exchange membrane 106, and a second chamber 122 is formed by the first cation exchange membrane 103 and the second anion exchange membrane 105. The second chamber 122 is initially filled with sulfuric acid aqueous solution. A chamber 124 formed between the anode 101 and the first bipolar membrane 104 and a chamber 125 formed between the second bipolar membrane 108 and the cathode 109 may be filled with any electrode solution. As far as the membranes facing the anode 101 and the cathode 109 are concerned, either the first anion exchange membrane 102 or the first cation exchange membrane 103, and either the third anion exchange membrane 106 or the second cation exchange membrane 107 can be used instead of the first bipolar membrane 104 and the second bipolar membrane 108, respectively, depending on the type of electrode solution.

The first chamber 120 communicates with both the regeneration wastewater outflow line 7 and the ammonia water supply line 13. That is, the first chamber 120 is configured such that the regeneration wastewater is supplied to the first chamber 120 through the regeneration wastewater outflow line 7, and that the ammonia water is discharged from the first chamber 120 through the ammonia water supply line 13. The second chamber 122 communicates with the regeneration acidic aqueous solution supply line 11. That is, the second chamber 122 is configured such that the regeneration acidic aqueous solution is discharged from the second chamber 122 through the regeneration acidic aqueous solution supply line 11. Further, a regeneration acidic aqueous solution return line 19 branches off from the regeneration acidic aqueous solution supply line 11, and the regeneration acidic aqueous solution return line 19 is connected to the second chamber 122. That is, it is configured such that part of regeneration acidic aqueous solution flowing through the regeneration acidic aqueous solution supply line 11 is supplied to the second chamber 122 through the regeneration acidic aqueous solution return line 19.

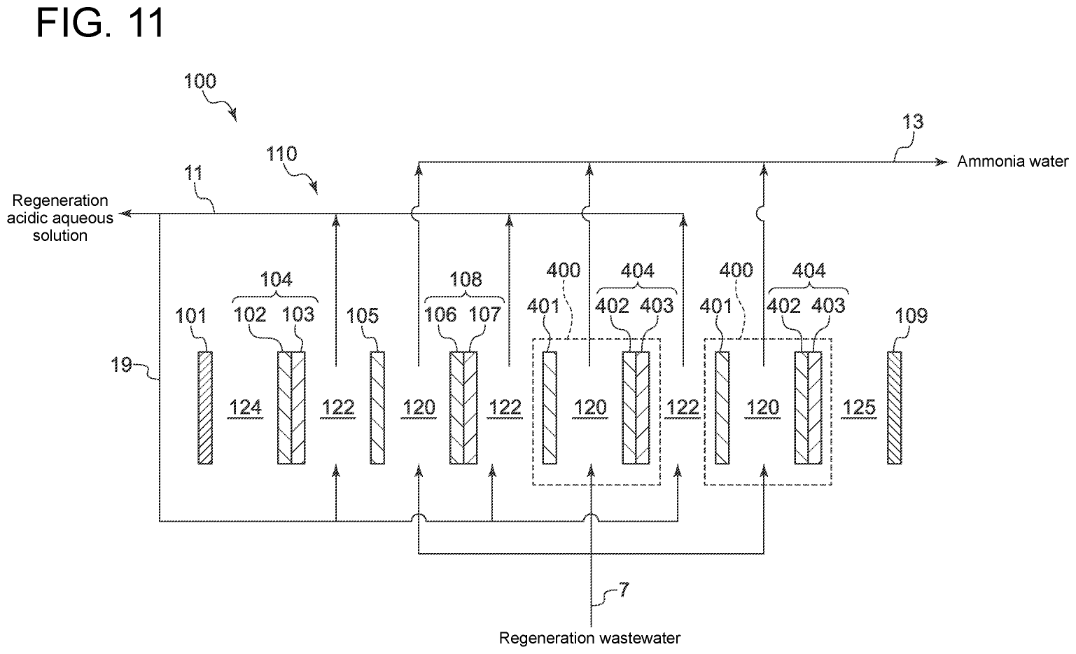

As shown in FIG. 11, the cell 110 may include, between the second bipolar membrane 108 and the cathode 109, a repeating unit 400 that includes: a fourth anion exchange membrane 401 facing the second cation exchange membrane 107; and a third bipolar membrane 404 including a fifth anion exchange membrane 402 facing the fourth anion exchange membrane 401 and a third cation exchange membrane 403. Although FIG. 11 shows a configuration in which the cell 110 has two repeating units 400, it is not limited to this embodiment. The cell 110 may have one repeating unit 400 or any number of repeating units 400, three or more.

When the cell 110 has one repeating unit 400, the first chamber 120 is formed by the fourth anion exchange membrane 401 and the third bipolar membrane 404, and the second chamber 122 is formed by the second bipolar membrane 108 and the fourth anion exchange membrane 401. When the cell 110 has two or more repeating units 400, the first chamber 120 is formed by the fourth anion exchange membrane 401 and the third bipolar membrane 404 in each repeating unit 400, and the second chamber 122 is also formed by the third bipolar membrane 404 of one of two adjacent repeating units 400, 400 and the fourth anion exchange membrane 401 of the other of the two adjacent repeating units 400, 400.

As shown in FIG. 10, the regeneration wastewater flows into the first chamber 120 of the bipolar membrane electrodialyzer 100. By applying a current between the anode 101 and the cathode 109, the regeneration wastewater is electrodialyzed. Sulfate ions in the regeneration wastewater flowing in the first chamber 120 are attracted to the anode 101 and flow through the second anion exchange membrane 105 into the second chamber 122. In each of the first bipolar membrane 104 and the second bipolar membrane 108, water is absorbed into the membrane by absorption and dissociates into hydrogen ions and hydroxide ions at the boundary between the first anion exchange membrane 102 and the first cation exchange membrane 103 and at the boundary between the third anion exchange membrane 106 and the second cation exchange membrane 107, respectively. Hydrogen ions thus generated flow through the first cation exchange membrane 103 and the second cation exchange membrane 107 into the second chamber 122 and the chamber 125, respectively, while hydroxide ions flow through the first anion exchange membrane 102 and the third anion exchange membrane 106 into the chamber 124 and the first chamber 120, respectively.

Sulfate ions in the regeneration wastewater flowing in the first chamber 120 are attracted to the anode 101 and flow through the second anion exchange membrane 105 into the second chamber 122. Since sulfate ions in the first chamber 120 move to the second chamber 122, and hydrogen ions flow from the first bipolar membrane 104 to the second chamber 122, the concentration of sulfuric acid in the second chamber 122 increases. On the other hand, since ammonium ions in the regeneration wastewater flowing in the first chamber 120 remains in the first chamber 120, and hydroxide ions flow from the second bipolar membrane 108 to the first chamber 120, the concentration of ammonia in the first chamber 120 increases. As a result, an aqueous solution with a lower concentration of ammonium sulfate and a higher concentration of ammonia than the regeneration wastewater flowing in the first chamber 120, i.e., ammonia water that may contain ammonium sulfate, is discharged from the first chamber 120. From the second chamber 122, sulfuric acid aqueous solution, i.e., regeneration acidic aqueous solution is discharged. Part of the regeneration acidic aqueous solution discharged from the second chamber 122 is supplied to the second chamber 122 through the regeneration acidic aqueous solution return line 19.

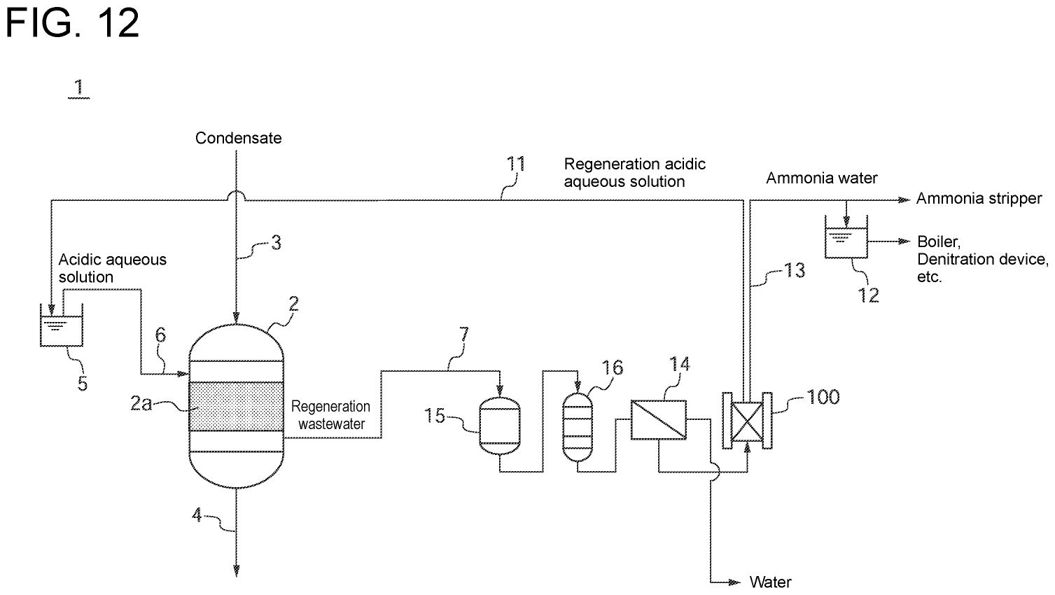

However, in this modification, ammonia water discharged from the first chamber 120 may have low purity as ammonia water due to remaining ammonium sulfate in the regeneration water. For this reason, as shown in FIG. 12, instead of the ammonia water storage tank 12 connected to the ammonia water supply line 13, an ammonia stripper of the same configuration as the ammonia stripper 50 (see FIG. 3) provided in the wastewater treatment system 1 of the second embodiment may be connected to the ammonia water supply line 13 to remove ammonia from the low purity ammonia water. In the second embodiment, an alkaline aqueous solution is supplied to the regeneration wastewater for the purpose of adjusting pH to enable removal of ammonia in the ammonia stripper 50, but in this modification, since the pH of the ammonia water discharged from the first chamber 120 is at least 11 or more, there is no need to supply an alkaline aqueous solution to the ammonia water discharged from the first chamber 120 for the purpose of adjusting pH.

The contents described in the above embodiments would be understood as follows, for instance.

[1] A wastewater treatment system according to one aspect is a wastewater treatment system (1) for treating regeneration wastewater generated by a regeneration process using an acidic aqueous solution for a desalination device (2) for desalting water containing ammonia and includes a bipolar membrane electrodialyzer (8/18) for separating, from the regeneration wastewater containing an ammonia salt produced by reaction between ammonia captured by the desalination device (2) and the acidic aqueous solution or from a solution derived from the regeneration wastewater, an aqueous solution containing an acidic solute that is the same as the acidic aqueous solution as a regeneration acidic aqueous solution. The wastewater treatment system is configured such that the regeneration acidic aqueous solution is used as at least part of the acidic aqueous solution for regeneration of the desalination device (2).

With the wastewater treatment system according to the present disclosure, by separating a regeneration acidic aqueous solution from regeneration wastewater generated by regenerating the desalination device with an acidic aqueous solution or from a solution derived from the regeneration wastewater, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

[2] A wastewater treatment system according to another aspect is the wastewater treatment system of [1], in which the bipolar membrane electrodialyzer (8) includes: an anode (21); a cathode (29); and a cell (30) disposed between the anode (21) and the cathode (29). The cell (30) includes: a first bipolar membrane (24) including a first anion exchange membrane (22) and a first cation exchange membrane (23); a second cation exchange membrane (25) facing the first cation exchange membrane (23); and a second bipolar membrane (28) including a second anion exchange membrane (26) facing the second cation exchange membrane (25) and a third cation exchange membrane (27). The bipolar membrane electrodialyzer is configured such that the regeneration wastewater is supplied to a first chamber (31) defined by the first bipolar membrane (24) and the second cation exchange membrane (25), and that the regeneration acidic aqueous solution is discharged from the first chamber (31).

With this configuration, by separating a regeneration acidic aqueous solution from regeneration wastewater generated by regenerating the desalination device with an acidic aqueous solution, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

[3] A wastewater treatment system according to still another aspect is the wastewater treatment system of [2], in which the cell (30) includes, between the second bipolar membrane (28) and the cathode (29), at least one repeating unit (200) that includes: a fourth cation exchange membrane (201) facing the third cation exchange membrane (27); and a third bipolar membrane (204) including a third anion exchange membrane (202) facing the fourth cation exchange membrane (201) and a fifth cation exchange membrane (203). The first chamber (31) is defined by the second bipolar membrane (28) and the fourth cation exchange membrane (201).

With this configuration, since the capacity of the cell of the bipolar membrane electrodialyzer increases, the efficiency of electrodialysis increases, so that the cost of the regeneration process of the desalination device can be reduced.

[4] A wastewater treatment system according to still another aspect is the wastewater treatment system of [3], in which the cell includes at least two repeating units (200), and the first chamber (31) is defined by the third bipolar membrane (204) of one of two adjacent repeating units (200, 200) and the fourth cation exchange membrane (201) of the other of the two adjacent repeating units (200, 200).

With this configuration, since the capacity of the cell of the bipolar membrane electrodialyzer increases, the efficiency of electrodialysis increases, so that the cost of the regeneration process of the desalination device can be reduced.

[5] A wastewater treatment system according to still another aspect is the wastewater treatment system of [1], in which the bipolar membrane electrodialyzer (100) includes: an anode (101); a cathode (109); and a cell (110) disposed between the anode (101) and the cathode (109). The cell (110) includes: a first bipolar membrane (104) including a first anion exchange membrane (102) and a first cation exchange membrane (103); a second anion exchange membrane (105) facing the first cation exchange membrane (103); and a second bipolar membrane (108) including a third anion exchange membrane (106) facing the second anion exchange membrane (105) and a second cation exchange membrane (107). The bipolar membrane electrodialyzer is configured such that the regeneration wastewater is supplied to a first chamber (120) defined by the second anion exchange membrane (105) and the third anion exchange membrane (106), and that the regeneration acidic aqueous solution is discharged from a second chamber (122) defined by the first cation exchange membrane (103) and the second anion exchange membrane (105).

With this configuration, by separating a regeneration acidic aqueous solution from regeneration wastewater generated by regenerating the desalination device with an acidic aqueous solution, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

[6] A wastewater treatment system according to still another aspect is the wastewater treatment system of [5], in which the cell (110) includes, between the second bipolar membrane (108) and the cathode (109), at least one repeating unit (400) that includes: a fourth anion exchange membrane (401) facing the second cation exchange membrane (107); and a third bipolar membrane (404) including a fifth anion exchange membrane (402) facing the fourth anion exchange membrane (401) and a third cation exchange membrane (403). The first chamber (120) is defined by the fourth anion exchange membrane (401) and the third bipolar membrane (404), and the second chamber (122) is defined by the second bipolar membrane (108) and the fourth anion exchange membrane (401).

With this configuration, since the capacity of the cell of the bipolar membrane electrodialyzer increases, the efficiency of electrodialysis increases, so that the cost of the regeneration process of the desalination device can be reduced.

[7] A wastewater treatment system according to still another aspect is the wastewater treatment system of [6], in which the cell includes at least two repeating units (400), the first chamber (120) is defined by the fourth anion exchange membrane (401) and the third bipolar membrane (404) in each of the repeating units (400), and the second chamber (122) is defined by the third bipolar membrane (404) of one of two adjacent repeating units (400, 400) and the fourth anion exchange membrane (401) of the other of the two adjacent repeating units (400, 400).

With this configuration, since the capacity of the cell of the bipolar membrane electrodialyzer increases, the efficiency of electrodialysis increases, so that the cost of the regeneration process of the desalination device can be reduced.

[8] A wastewater treatment system according to still another aspect is the wastewater treatment system of any one of [5] to [7], in which the bipolar membrane electrodialyzer (100) is configured such that ammonia water is discharged from the first chamber (120). The wastewater treatment system (1) further includes an ammonia stripper (50) for separating ammonia from the ammonia water discharged from the first chamber (120).

With this configuration, when the purity of ammonia water discharged from each of the first chamber and the second chamber is low, it can be disposed of without being used in a boiler, a denitration device, etc.

[9] A wastewater treatment system according to still another aspect is the wastewater treatment system of [1], in which the bipolar membrane electrodialyzer (18) includes: an anode (71); a cathode (80); and a cell (90) disposed between the anode (71) and the cathode (80). The cell (90) includes: a first bipolar membrane (74) including a first anion exchange membrane (72) and a first cation exchange membrane (73); a second anion exchange membrane (75) facing the first cation exchange membrane (73); a second cation exchange membrane (76) facing the second anion exchange membrane (75); and a second bipolar membrane (79) including a third anion exchange membrane (77) facing the second cation exchange membrane (76) and a third cation exchange membrane (78). The bipolar membrane electrodialyzer is configured such that the regeneration wastewater is supplied to a first chamber (81) defined by the second anion exchange membrane (75) and the second cation exchange membrane (76), and that the regeneration acidic aqueous solution is discharged from a second chamber (82) defined by the first bipolar membrane (74) and the second anion exchange membrane (75).

With this configuration, by separating a regeneration acidic aqueous solution from regeneration wastewater generated by regenerating the desalination device with an acidic aqueous solution, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

[10] A wastewater treatment system according to still another aspect is the wastewater treatment system of [9], in which the cell (90) includes, between the second bipolar membrane (79) and the cathode (80), at least one repeating unit (300) that includes: a fourth anion exchange membrane (301) facing the third cation exchange membrane (78); a fourth cation exchange membrane (302) facing the fourth anion exchange membrane (301); and a third bipolar membrane (305) including a fifth anion exchange membrane (303) facing the fourth cation exchange membrane (302) and a fifth cation exchange membrane (304). The first chamber (81) is defined by the fourth anion exchange membrane (301) and the fourth cation exchange membrane (302), and the second chamber (82) is defined by the second bipolar membrane (79) and the fourth anion exchange membrane (301).

With this configuration, since the capacity of the cell of the bipolar membrane electrodialyzer increases, the efficiency of electrodialysis increases, so that the cost of the regeneration process of the desalination device can be reduced.

[11] A wastewater treatment system according to still another aspect is the wastewater treatment system of [10], in which the cell includes at least two repeating units (300), the first chamber (81) is defined by the fourth anion exchange membrane (301) and the fourth cation exchange membrane (302) in each of the repeating units (300), and the second chamber (82) is defined by the third bipolar membrane (305) of one of two adjacent repeating units (300, 300) and the fourth anion exchange membrane (301) of the other of the two adjacent repeating units (300, 300).

With this configuration, since the capacity of the cell of the bipolar membrane electrodialyzer increases, the efficiency of electrodialysis increases, so that the cost of the regeneration process of the desalination device can be reduced.

[12] A wastewater treatment system according to still another aspect is the wastewater treatment system of any one of [1] to [8], further including a concentrator (14) for concentrating the ammonia salt of the regeneration wastewater before flowing in the bipolar membrane electrodialyzer (8).

When the concentration of ammonium salt in the regeneration wastewater is low, the separation efficiency of regeneration acidic aqueous solution by electrodialysis decreases, but with the above concentration [6], electrodialysis can be performed on the regeneration wastewater with a higher concentration of ammonium salt, so that the separation efficiency of regeneration acidic aqueous solution by electrodialysis can be improved.

[13] A wastewater treatment system according to still another aspect is the wastewater treatment system of any one of [9] to [11], in which the bipolar membrane electrodialyzer (18) is configured such that ammonia water is discharged from a third chamber (83) defined by the second cation exchange membrane (76) and the second bipolar membrane (79), and that a dilution solution which is a remaining component of the regeneration wastewater from which the regeneration acidic aqueous solution and the ammonia water have been separated is discharged from the first chamber (81). The wastewater treatment system further includes: a concentrator (14) for concentrating the ammonia salt of the regeneration wastewater before flowing in the bipolar membrane electrodialyzer (18); and a dilution solution return line (62) for supplying the dilution solution discharged from the first chamber (81) to the regeneration wastewater before flowing in the concentrator (14).

With this configuration, the dilution solution and the regeneration wastewater can be concentrated together and then electrodialyzed again. Thus, the separation amount of the regeneration acidic aqueous solution and the regeneration alkaline aqueous solution can be increased compared to the case where the dilution solution is not supplied to the regeneration wastewater before flowing in the concentrator.

[14] A wastewater treatment system according to still another aspect is the wastewater treatment system of [1], including: a supply device (40) for supplying an alkaline aqueous solution containing a hydroxide of an alkali metal to the regeneration wastewater; and an ammonia stripper (50) for separating ammonia from the regeneration wastewater supplied with the alkaline aqueous solution. The solution derived from the regeneration wastewater is a waste solution from the ammonia stripper (50). The bipolar membrane electrodialyzer is configured such that the regeneration acidic aqueous solution and a regeneration alkaline aqueous solution as an aqueous solution containing a solute that is the same as the alkaline aqueous solution are separately separated from the waste solution, and that the regeneration alkaline aqueous solution is supplied to the regeneration wastewater as at least part of the alkaline aqueous solution.

With this configuration, by supplying an alkaline aqueous solution to regeneration wastewater generated by regenerating the desalination device with an acidic aqueous solution to separate ammonia by the ammonia stripper, separating a regeneration acidic aqueous solution and a regeneration alkaline aqueous solution from a waste solution from the ammonia stripper, and reusing the regeneration acidic aqueous solution as at least part of the acidic aqueous solution for regeneration of the desalination device while supplying the regeneration alkaline aqueous solution to the regeneration wastewater as at least part of the alkaline aqueous solution, the consumption of the acidic aqueous solution and the alkaline aqueous solution can be reduced, so that the cost of the regeneration process of the desalination device can be reduced.

[15] A wastewater treatment system according to still another aspect is the wastewater treatment system of [14], in which the bipolar membrane electrodialyzer (18) includes: an anode (71); a cathode (80); and a cell (90) disposed between the anode (71) and the cathode (80). The cell (90) includes: a first bipolar membrane (74) including a first anion exchange membrane (72) and a first cation exchange membrane (73); a second anion exchange membrane (75) facing the first cation exchange membrane (73); a second cation exchange membrane (76) facing the second anion exchange membrane (75); and a second bipolar membrane (79) including a third anion exchange membrane (77) facing the second cation exchange membrane (76) and a third cation exchange membrane (78). The bipolar membrane electrodialyzer is configured such that the waste solution is supplied to a first chamber (81) defined by the second anion exchange membrane (75) and the second cation exchange membrane (76), that the regeneration acidic aqueous solution is discharged from a second chamber (82) defined by the first bipolar membrane (74) and the second anion exchange membrane (75), and that the regeneration alkaline aqueous solution is discharged from a third chamber (83) defined by the second cation exchange membrane (76) and the second bipolar membrane (79).

With this configuration, by supplying an alkaline aqueous solution to regeneration wastewater generated by regenerating the desalination device with an acidic aqueous solution to separate ammonia by the ammonia stripper, separating a regeneration acidic aqueous solution and a regeneration alkaline aqueous solution from a waste solution from the ammonia stripper, and reusing the regeneration acidic aqueous solution as at least part of the acidic aqueous solution for regeneration of the desalination device while supplying the regeneration alkaline aqueous solution to the regeneration wastewater as at least part of the alkaline aqueous solution, the consumption of the acidic aqueous solution and the alkaline aqueous solution can be reduced, so that the cost of the regeneration process of the desalination device can be reduced.

[16] A wastewater treatment system according to still another aspect is the wastewater treatment system of [15], in which the cell (90) includes, between the second bipolar membrane (79) and the cathode (80), at least one repeating unit (300) that includes: a fourth anion exchange membrane (301) facing the third cation exchange membrane (78); a fourth cation exchange membrane (302) facing the fourth anion exchange membrane (301); and a third bipolar membrane (305) including a fifth anion exchange membrane (303) facing the fourth cation exchange membrane (302) and a fifth cation exchange membrane (304). The first chamber (81) is defined by the fourth anion exchange membrane (301) and the fourth cation exchange membrane (302), the second chamber (82) is defined by the second bipolar membrane (79) and the fourth anion exchange membrane (301), and the third chamber (83) is defined by the fourth cation exchange membrane (302) and the third bipolar membrane (305).

With this configuration, since the capacity of the cell of the bipolar membrane electrodialyzer increases, the efficiency of electrodialysis increases, so that the cost of the regeneration process of the desalination device can be reduced.

[17] A wastewater treatment system according to still another aspect is the wastewater treatment system of [16], in which the cell includes at least two repeating units (300), the first chamber (81) is defined by the fourth anion exchange membrane (301) and the fourth cation exchange membrane (302) in each of the repeating units (300), the second chamber (82) is defined by the third bipolar membrane (305) of one of two adjacent repeating units (300, 300) and the fourth anion exchange membrane (301) of the other of the two adjacent repeating units (300, 300), and the third chamber (83) is defined by the fourth cation exchange membrane (302) and the third bipolar membrane (305) in each of the repeating units (300).

With this configuration, since the capacity of the cell of the bipolar membrane electrodialyzer increases, the efficiency of electrodialysis increases, so that the cost of the regeneration process of the desalination device can be reduced.

[18] A wastewater treatment system according to still another aspect is the wastewater treatment system of any one of to [17], further including a concentrator (14) for concentrating a salt of the alkali metal produced by reaction between the ammonia salt contained in the regeneration wastewater and the hydroxide of the alkali metal contained in the alkaline aqueous solution, for the waste solution before flowing in the bipolar membrane electrodialyzer (18).

When the concentration of salt of the alkali metal in the waste solution from the ammonia stripper is low, the separation efficiency of regeneration acidic aqueous solution and regeneration alkaline aqueous solution by electrodialysis decreases, but with the above concentration [18], electrodialysis can be performed on the waste solution with a higher concentration of salt of the alkali metal, so that the separation efficiency of regeneration acidic aqueous solution and regeneration alkaline aqueous solution by electrodialysis can be improved.

[19] A wastewater treatment system according to still another aspect is the wastewater treatment system of [18], further including a dilution solution return line (62) for supplying a dilution solution which is a remaining component of the waste solution from which the acidic aqueous solution and the alkaline aqueous solution have been separated to the waste solution before flowing in the concentrator (14).

With this configuration, the dilution solution and the waste solution can be concentrated together and then electrodialyzed again. Thus, the separation amount of the regeneration acidic aqueous solution and the regeneration alkaline aqueous solution can be increased compared to the case where the dilution solution is not supplied to the waste solution before flowing in the concentrator.

[20] A wastewater treatment system according to still another aspect is the wastewater treatment system of any one of [1] to [19], in which the water containing ammonia is condensate from a boiler.

With the wastewater treatment system according to the present disclosure, by separating a regeneration acidic aqueous solution from regeneration wastewater generated by a regeneration process with an acidic aqueous solution applied to a desalination device for desalting boiler condensate containing ammonia or from a solution derived from the regeneration wastewater, and reusing the regeneration acidic aqueous solution as at least part of the acidic aqueous solution for regeneration of the desalination device, the consumption of the acidic aqueous solution can be reduced, so that the cost of the regeneration process of the desalination device can be reduced.

### REFERENCE SIGNS LIST

1 Wastewater treatment system
2 Desalination device
8 Bipolar membrane electrodialyzer
14 Concentrator
18 Bipolar membrane electrodialyzer
21 Anode
22 First anion exchange membrane
23 First cation exchange membrane
24 First bipolar membrane
25 Second cation exchange membrane
26 Second anion exchange membrane
27 Third cation exchange membrane
28 Second bipolar membrane
29 Cathode
30 Cell
31 First chamber
40 Supply device
50 Ammonia stripper
62 Dilution solution return line
71 Anode
72 First anion exchange membrane
73 First cation exchange membrane
74 First bipolar membrane
75 Second anion exchange membrane
76 Second cation exchange membrane
77 Third anion exchange membrane
78 Third cation exchange membrane
79 Second bipolar membrane
80 Cathode
81 First chamber
82 Second chamber
83 Third chamber
90 Cell
100 Bipolar membrane electrodialyzer
101 Anode
102 First anion exchange membrane
103 First cation exchange membrane
104 First bipolar membrane
105 Second anion exchange membrane
106 Third anion exchange membrane
107 Second cation exchange membrane
108 Second bipolar membrane
109 Cathode
110 Cell
120 First chamber
122 Second chamber
200 Repeating unit
201 Fourth cation exchange membrane
202 Third anion exchange membrane
203 Fifth cation exchange membrane
204 Third bipolar membrane
300 Repeating unit
301 Fourth anion exchange membrane
302 Fourth cation exchange membrane
303 Fifth anion exchange membrane
304 Fifth cation exchange membrane
305 Third bipolar membrane
400 Repeating unit
401 Fourth anion exchange membrane
402 Fifth anion exchange membrane
403 Third cation exchange membrane
404 Third bipolar membrane

1. (canceled)

2. A wastewater treatment system for treating regeneration wastewater generated by a regeneration process using an acidic aqueous solution for a desalination device for desalting water containing ammonia, comprising:
a bipolar membrane electrodialyzer for separating, from the regeneration wastewater containing an ammonia salt produced by reaction between ammonia captured by the desalination device and the acidic aqueous solution or from a solution derived from the regeneration wastewater, an aqueous solution containing an acidic solute that is the same as the acidic aqueous solution as a regeneration acidic aqueous solution,
wherein the wastewater treatment system is configured such that the regeneration acidic aqueous solution is used as at least part of the acidic aqueous solution for regeneration of the desalination device,
wherein the bipolar membrane electrodialyzer includes:
an anode;
a cathode; and
a cell disposed between the anode and the cathode,
wherein the cell includes:
a first bipolar membrane including a first anion exchange membrane and a first cation exchange membrane;
a second cation exchange membrane facing the first cation exchange membrane; and
a second bipolar membrane including a second anion exchange membrane facing the second cation exchange membrane and a third cation exchange membrane, and
wherein the bipolar membrane electrodialyzer is configured such that the regeneration wastewater is supplied to a first chamber defined by the first bipolar membrane and the second cation exchange membrane, and that the regeneration acidic aqueous solution is discharged from the first chamber.

3. The wastewater treatment system according to claim 2,
wherein the cell includes, between the second bipolar membrane and the cathode, at least one repeating unit that includes: a fourth cation exchange membrane facing the third cation exchange membrane; and a third bipolar membrane including a third anion exchange membrane facing the fourth cation exchange membrane and a fifth cation exchange membrane, and
wherein the first chamber is defined by the second bipolar membrane and the fourth cation exchange membrane.

4. The wastewater treatment system according to claim 3, wherein the cell includes at least two repeating units, and the first chamber is defined by the third bipolar membrane of one of two adjacent repeating units and the fourth cation exchange membrane of the other of the two adjacent repeating units.

5.-8. (canceled)

9. A wastewater treatment system for treating regeneration wastewater generated by a regeneration process using an acidic aqueous solution for a desalination device for desalting water containing ammonia, comprising:
a bipolar membrane electrodialyzer for separating, from the regeneration wastewater containing an ammonia salt produced by reaction between ammonia captured by the desalination device and the acidic aqueous solution or from a solution derived from the regeneration wastewater, an aqueous solution containing an acidic solute that is the same as the acidic aqueous solution as a regeneration acidic aqueous solution,
wherein the wastewater treatment system is configured such that the regeneration acidic aqueous solution is used as at least part of the acidic aqueous solution for regeneration of the desalination device,
wherein the bipolar membrane electrodialyzer includes:
an anode;
a cathode; and
a cell disposed between the anode and the cathode,
wherein the cell includes:
a first bipolar membrane including a first anion exchange membrane and a first cation exchange membrane;
a second anion exchange membrane facing the first cation exchange membrane;
a second cation exchange membrane facing the second anion exchange membrane; and
a second bipolar membrane including a third anion exchange membrane facing the second cation exchange membrane and a third cation exchange membrane, and
wherein the bipolar membrane electrodialyzer is configured such that the regeneration wastewater is supplied to a first chamber defined by the second anion exchange membrane and the second cation exchange membrane, and that the regeneration acidic aqueous solution is discharged from a second chamber defined by the first bipolar membrane and the second anion exchange membrane.

10. The wastewater treatment system according to claim 9,
wherein the cell includes, between the second bipolar membrane and the cathode, at least one repeating unit that includes: a fourth anion exchange membrane facing the third cation exchange membrane; a fourth cation exchange membrane facing the fourth anion exchange membrane; and a third bipolar membrane including a fifth anion exchange membrane facing the fourth cation exchange membrane and a fifth cation exchange membrane, and
wherein the first chamber is defined by the fourth anion exchange membrane and the fourth cation exchange membrane, and the second chamber is defined by the second bipolar membrane and the fourth anion exchange membrane.

11. The wastewater treatment system according to claim 10, wherein the cell includes at least two repeating units, the first chamber is defined by the fourth anion exchange membrane and the fourth cation exchange membrane in each of the repeating units, and the second chamber is defined by the third bipolar membrane of one of two adjacent repeating units and the fourth anion exchange membrane of the other of the two adjacent repeating units.

12. The wastewater treatment system according to claim 2, further comprising a concentrator for concentrating the ammonia salt of the regeneration wastewater before flowing in the bipolar membrane electrodialyzer.

13. The wastewater treatment system according to claim 9,
wherein the bipolar membrane electrodialyzer is configured such that ammonia water is discharged from a third chamber defined by the second cation exchange membrane and the second bipolar membrane, and that a dilution solution which is a remaining component of the regeneration wastewater from which the regeneration acidic aqueous solution and the ammonia water have been separated is discharged from the first chamber, and
wherein the wastewater treatment system further comprises:
a concentrator for concentrating the ammonia salt of the regeneration wastewater before flowing in the bipolar membrane electrodialyzer; and
a dilution solution return line for supplying the dilution solution discharged from the first chamber to the regeneration wastewater before flowing in the concentrator.

14.-19. (canceled)

20. The wastewater treatment system according to claim 2, wherein the water containing ammonia is condensate from a boiler.

21. The wastewater treatment system according to claim 9, wherein the water containing ammonia is condensate from a boiler.
